(19) United States
(12) Patent Application Publication
(10) Pub. No.: US 2023/0232799 A1
(43) Pub. Date: Jul. 27, 2023

(54) Fishing Net Hoop Device and Method of Use

(71) Applicant: Joseph Boothe, Jackson, AL (US)

(72) Inventor: Joseph Boothe, Jackson, AL (US)

(21) Appl. No.: 18/157,829

(22) Filed: Jan. 22, 2023

Related U.S. Application Data
(60) Provisional application No. 63/301,683, filed on Jan. 21, 2022.

(51) Int. Cl. A01K 75/00

(52) U.S. Cl. CPC A01K 75/005

(57) ABSTRACT

The present invention relates generally to the field of fishing devices. More specifically, the present invention relates to a fishing net hoop device. The device is comprised of a hoop and a net. The hoop keeps the net open to increase the probability that fish will swim into the net. In one embodiment, the net is comprised of at least one fastener that attaches to the hoop, to allow the net to be removable so that damaged nets can be conveniently replaced. In one embodiment, the device is comprised of at least one transmitter, at least one tracking device, and at least one battery. The transmitter is in electrical communication with a mobile application on the user's smart device to allow a user to locate the device if it is lost in a body of water.

### CROSS-REFERENCE TO RELATED APPLICATION

The present application claims priority to, and the benefit of, U.S. Provisional Application No. 63/301,683, which was filed on Jan. 21, 2021, and is incorporated herein by reference in its entirety.

### FIELD OF THE INVENTION

The present invention relates generally to the field of fishing devices. More specifically, the present invention relates to a fishing net hoop device. The device is comprised of a hoop and a net. The hoop keeps the net open to increase the probability that fish will swim into the net. The device may also be comprised of at least one transmitter, at least one tracking device, and at least one battery. The transmitter is in electrical communication with a mobile application on the user's smart device to allow a user to locate the device if it is lost in a body of water. Accordingly, the present disclosure makes specific reference thereto. Nonetheless, it is to be appreciated that aspects of the present invention are also equally applicable to other like applications, devices and methods of manufacture.

### BACKGROUND

Fishing netting can be difficult to hold open to allow more fish to be captured by the net. As a result, fishermen may not be able to catch as many fish as they otherwise would be able to catch due to the inability to keep a fishing net open. Fishing with existing fishing nets puts anglers at a significant disadvantage and greatly restricts their ability to catch fish. Further, existing fishing nets with metal hoops often rust and decay quickly, thereby forcing the fisherman to spend copious amounts of money on fishing nets.

Further, while river fishing it is possible to lose a grip on a fishing net. As a result, the net may float downstream which can prohibit its recovery. This is undesirable, as a fisherman must then purchase a replacement net.

Therefore, there exists a long-felt need in the art an improved fishing net hoop device. There also exists a long-felt need in the art for a fishing net hoop device that holds a fishing net open to allow more fish to be captured by the net. In addition, there exists a long-felt need in the art for a fishing net hoop device that is corrosion-resistant and does not decay at a rapid rate. Further, there exists a long-felt need in the art for a fishing net device that a user can track and locate if it is lost while in use. Finally, there exists a long-felt need in the art for a fishing net hoop device that limits the need for a user to spend money frequently on new fishing nets.

The subject matter disclosed and claimed herein, in one embodiment thereof, comprises a fishing net hoop device. The device is comprised of a hoop and a net. During use, the hoop keeps the net open to increase the probability that fish will swim into and become captured by the net. In one embodiment, the net is comprised of at least one fastener that attaches to the hoop to allow the net to be removable so that damaged nets can be easily replaced. The net is also comprised of an interior netting and an exterior netting to prevent fish from escaping the net through holes/rips in the netting. In one embodiment, the device is comprised of at least one transmitter, at least one tracking device, and at least one battery. The transmitter is in electrical communication with a mobile application on the user's smart device to allow a user to locate the device if it is lost in a body of water.

In this manner, the fishing net hoop device of the present invention accomplishes all of the foregoing objectives and provides an improved fishing net hoop device. To do so, the device keeps a fishing net open to improve the likelihood that a user will catch more fish. The device also provides a novel means to locate lost fishing nets.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing net hoop device. The fishing net hoop device is primarily comprised of at least one hoop. In the preferred embodiment, the hoop is manufactured from a galvanized steel material that prevents the hoop from rusting or decaying. The galvanized steel also promotes longevity and helps keep the hoop strong and sturdy.

In one embodiment, the device may be comprised of both a hoop and a net. This allows the user to have a device that is already completely functional and ready for use. The net is comprised of at least one exterior net, at least one interior net, and at least one fastener. The fastener attaches the netting to the hoop to ensure there is secure connection. Further, the fastener ensures the netting is removable in case the netting were to sustain damage, such as rips or holes. In this embodiment, the interior netting entangles the fish while the exterior netting functions as a second layer to ensure that no fish escape the netting.

In another embodiment, the device may be comprised of at least one tracking device, at least one transmitter, and at least one battery. In this embodiment, these elements are positioned within the hoop to protect them from water damage. The transmitter is in wireless electrical communication with a mobile application on the user's smart device. This allows for the mobile application to wirelessly communicate with the transmitter. When the device is lost in a body of water, the tracking device communicates with the transmitter which then communicates the location of the device to the mobile application. The tracking device and transmitter may further be powered by at least one battery.

The mobile application is preferably comprised of a tracking function, a map function, and a depth function. The tracking function allows a user to see where the device is located in proximity to the user's smart device. In this manner, a user can follow the location of the device to recover their lost device. The map function allows the user to see a map view of the surrounding location and where the device is located in connection with the map. This allows the user to be able to see potential hazards or other objects that may be near them. The depth function provides the user with a means to see how deep the device is in the water. This way the user will be able to have an idea of how difficult it will be to retrieve the device, or the tools that will be needed for the retrieval.

Accordingly, the fishing net hoop device of the present invention is particularly advantageous as it provides the user with an improved fishing hoop that keeps the net open to increase the probability of catching fish. The device further, provides a way for fisherman to locate their lost fishing nets. In this manner, the fishing net hoop device overcomes the limitations of existing fishing net devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a hoop of one potential embodiment of a fishing net hoop device of the present invention in accordance with the disclosed architecture;

FIG. 2 illustrates a perspective view of a hoop and net of one potential embodiment of a fishing net hoop device of the present invention in accordance with the disclosed architecture;

FIG. 3 illustrates an enhanced perspective view of a hoop of one potential embodiment of a fishing net hoop device of the present invention in accordance with the disclosed architecture;

FIG. 4 illustrates a graphical view of one potential embodiment of a mobile application of one potential embodiment of a fishing net hoop device of the present invention in accordance with the disclosed architecture; and

FIG. 5 illustrates a flowchart of one potential method of using one potential embodiment of the fishing net hoop device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved fishing net hoop device. There also exists a long-felt need in the art for a fishing net hoop device that holds a fishing net open to allow more fish to be captured by the net. In addition, there exists a long-felt need in the art for a fishing net hoop device that is corrosion-resistant and does not decay at a rapid rate. Further, there exists a long-felt need in the art for a fishing net device that a user can track and locate if it is lost while in use. Finally, there exists a long-felt need in the art for a fishing net hoop device that limits the need for a user to spend money frequently on new fishing nets.

The present invention, in one exemplary embodiment, is comprised of a fishing net hoop device. The device is primarily comprised of a hoop and a net. The hoop is preferably rust-resistant, promotes longevity, and prevents against decaying. The hoop further holds the net in an open position to increase the probability of catching fish. The net is further comprised of an interior net and an exterior net. This prevents any fish caught in the net from escaping. The net is also comprised of at least one fastener that allows the netting to be removably attached to the hoop, so the user can replace damaged netting.

The device may also be comprised of at least one tracking device, at least one transmitter, and at least one battery. The transmitter is in electrical communication with a mobile application on the user's smart device. This allows the user to be able to locate the device if it is lost while in use.

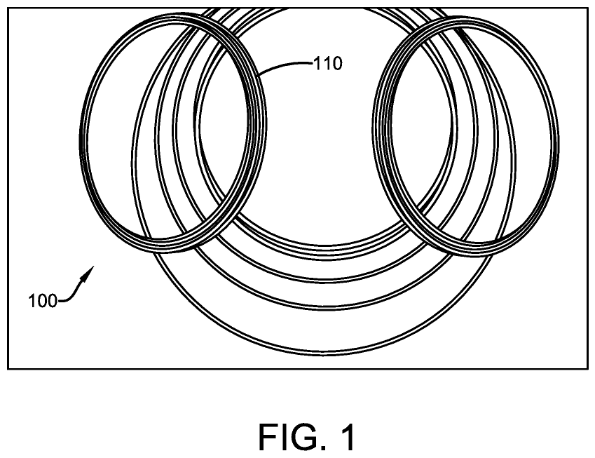

Referring initially to the drawings, FIG. 1 illustrates a perspective view of a hoop 110 of one potential embodiment of a fishing net hoop device 100 of the present invention in accordance with the disclosed architecture. The fishing net hoop device 100 is primarily comprised of at least one hoop 110. The hoop 110 can be manufactured from a plurality of metal materials such as but not limited to poly steel, copper, aluminum, stainless steel, tin, brass, bronze, titanium, oxidized steel, or combinations therein.

In a differing embodiment, the hoop 110 may be manufactured from any durable rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

In the preferred embodiment, the hoop 110 is manufactured from a galvanized steel material that prevents the hoop 110 from rusting or decaying. The galvanized steel thereby promotes longevity and keeps the hoop strong and sturdy.

The hoop 110 may be a plurality of shapes in different embodiments such as, but not limited to, ovular, octagonal, hexagonal, rectangular, square, triangular, pentagonal, circular. In the preferred embodiment, the hoop 110 is circular in shape to ensure the highest likelihood of catching fish. The hoop 110 can further be manufactured in a plurality of sizes. In one embodiment, the diameter of the hoop 110 is between 4-48″. The hoop 110 preferably is manufactured in a multitude of sizes to ensure that the hoop 110 is compatible with a plurality of fishing nets. The hoop may also be any color known in the art.

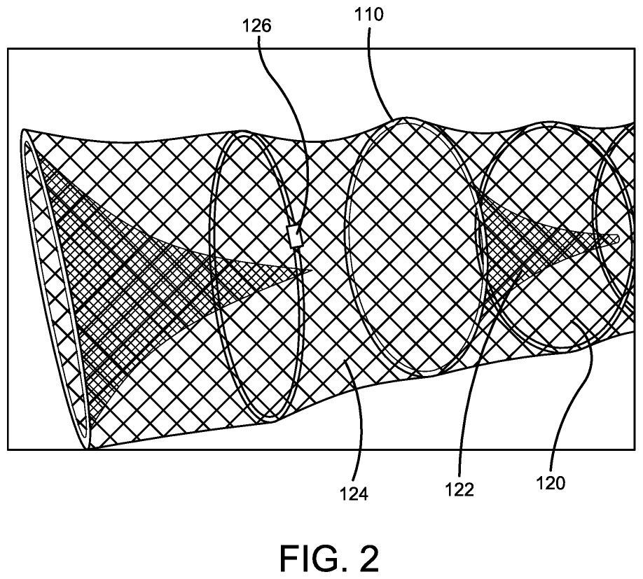

FIG. 2 illustrates a perspective view of a hoop 110 and net 120 of one potential embodiment of a fishing net hoop device 100 of the present invention in accordance with the disclosed architecture. In one embodiment, the device 100 may be comprised of both at least one hoop 110 and at least one net 120. The net 120 may be any net type such as but not limited to a fish net, a turtle net, a crab net, etc. The net 120 is comprised of at least one exterior net 124, at least one interior net 122, and at least one fastener 126. The fastener 126 attaches the net 120 to the hoop 110. Further, the fastener 126 makes the netting 120 removable in the event that the netting 120 sustains damage, such as rips or holes. There is a plurality of fasteners 126 that may be used to attach the net 120 to the hoop 110. The fasteners 126 that may be used are any fastener known in the art such as, but not limited to, a magnet, a screw, a bolt, an adhesive, a hook and loop fastener, a tongue and groove fastener, etc.

As noted, the netting 120 has an interior net 122 and an exterior net 124. The interior net 122 is what entangles the fish. The exterior netting 124 functions as a second layer to ensure that no fish escape the netting 120. In the preferred embodiment, the net 120 is manufactured from a nylon material such as, but not limited to, rubber coated nylon and non-rubber coated nylon. In differing embodiments, the netting 120 may be manufactured from any woven fibrous material such as, but not limited to, cotton, wool, tweed twill, polypropylene polyurethane, polyvinyl, polyethylene, silk, tulle, etc.

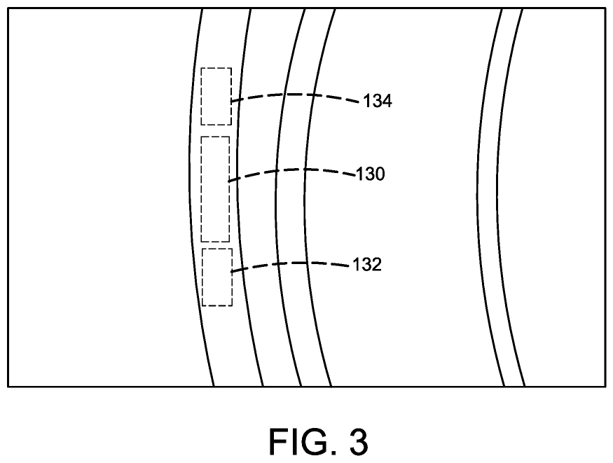

FIG. 3 illustrates an enhanced perspective view of a hoop 110 of one potential embodiment of a fishing net hoop device 100 of the present invention in accordance with the disclosed architecture. In another embodiment, the device 100 may be additionally comprised of at least one tracking device 130, at least one transmitter 132, and at least one battery 134. In this embodiment, these elements are positioned within the hoop 110 to protect them from water damage.

The tracking device 130 may be any tracking device known in the art. The device 100 is further comprised of at least one transmitter 132. The transmitter 132 may be any transmitter known in the art. The transmitter 132 is in wireless electrical communication with a mobile application 200 on a user's smart device. This allows for the mobile application 200 to wirelessly communicate with the transmitter 132.

When the device 100 is lost in a body of water, the tracking device 130 communicates with the transmitter 132 which then communicates the location of the device 100 to the mobile application 200. In different embodiments the electronic communication capabilities of the device 100 may be, but are not limited to, GPS, WIFI, Bluetooth, RFID, cellular, etc.

The tracking device 130 and transmitter 132 may further be powered by at least one battery 134. The battery 134 can be in the form of an alkaline, nickel-cadmium, nickel-metal hydride battery, etc. such as any 3V-12-volt DC battery 134 or other conventional battery 134 such as A, AA, AAA, etc. that supply power to the tracking device 130 and transmitter 132. Throughout this specification, the terms “battery” and “batteries” may be used interchangeably to refer to one or more wet or dry cells or batteries 134 of cells in which chemical energy is converted into electricity and used as a source of DC power. References to recharging or replacing batteries 134 may refer to recharging or replacing individual cells, individual batteries 134 of cells, or a package of multiple battery cells as is appropriate for any given battery 134 technology that may be used.

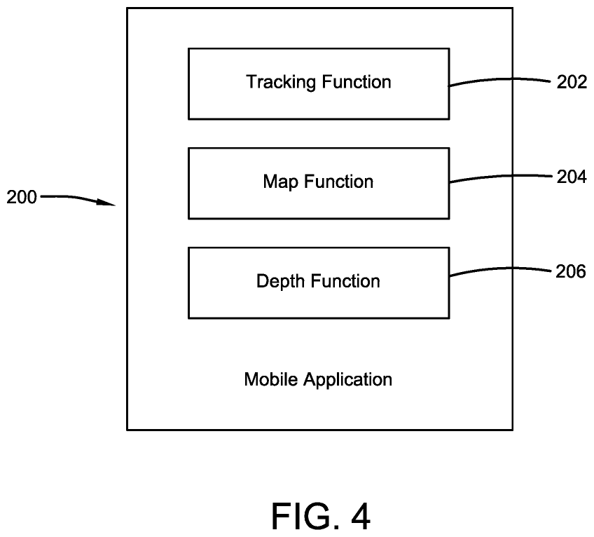

FIG. 4 illustrates a graphical view of one potential embodiment of a mobile application 200 of one potential embodiment of a fishing net hoop device 100 of the present invention in accordance with the disclosed architecture. The mobile application 200 is preferably comprised of a tracking function 202, a map function 204, and a depth function 206. The tracking function 202 allows a user to see where the device 100 is located in proximity to the user's smart device. In this manner, the user can follow the location of the device 100 to recover their lost device 100.

The map function 204 allows the user to see a map view where the device 100 is located. This allows the user to be able to see potential hazards or other objects that may be near them. The map function 204 may be any type of photographic, topographic, or other map type known in the art.

The depth function 206 provides the user with a means to see how deep the device 100 is in the water. As a result, the user will be able to have an idea of how difficult it will be to retrieve the device 100, or the tools that will be needed for the retrieval.

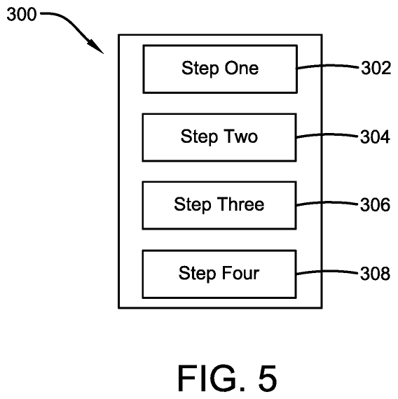

FIG. 5 illustrates a flowchart of one potential method 300 of using one potential embodiment of the fishing net hoop device 100 of the present invention in accordance with the disclosed architecture. First, the user places the hoop 110 within the net 120 [Step 302]. Then, the user attaches the net 120 to the hoop via fasteners 126 [Step 304]. Next, the user throws the device 100 into the body of water they wish to fish in [Step 306]. The position of the device 100 can then be determined using the mobile application 200 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fishing net hoop device” and “device” are interchangeable and refer to the fishing net hoop device 100 of the present invention.

Notwithstanding the foregoing, the fishing net hoop device 100 of the present invention and its various components can be of any suitable size and configuration as is known in the art without affecting the overall concept of the invention, provided that they accomplish the above-stated objectives. One of ordinary skill in the art will appreciate that the size, configuration and material of the fishing net hoop device 100 as shown in the FIGS. are for illustrative purposes only, and that many other sizes and shapes of the fishing net hoop device 100 are well within the scope of the present disclosure. Although the dimensions of the fishing net hoop device 100 are important design parameters for user convenience, the fishing net hoop device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing net hoop device comprising:
a hoop; and
a net.

2. The fishing net hoop device of claim 1, wherein a hoop is comprised of a galvanized steel.

3. The fishing net hoop device of claim 1, wherein a hoop is comprised in an ovular, an octagonal, a hexagonal, a rectangular, a square, a triangular, a pentagonal or a circular shape.

4. A fishing net hoop device comprising:
a hoop comprised of a corrosion-resistant material; and
a net.

5. The fishing net hoop device of claim 4, wherein the net is comprised of a fastener.

6. The fishing net hoop device of claim 5, wherein the fastener is comprised of a magnet, a screw, a bolt, an adhesive, a hook and loop fastener, or a tongue and groove fastener.

7. The fishing net hoop device of claim 4, wherein the net is comprised of an interior net.

8. The fishing net hoop device of claim 7, wherein the interior net is comprised of a nylon material.

9. The fishing net hoop device of claim 4, wherein the net is comprised of an exterior net.

10. The fishing net hoop device of claim 9, wherein the exterior net is comprised of a nylon material.

11. The fishing net hoop device of claim 4 further comprised of a tracking device.

12. The fishing net hoop device of claim 11, wherein the tracking device is positioned within the hoop.

13. The fishing net hoop device of claim 12, wherein the tracking device is comprised of a transmitter.

14. The fishing net hoop device of claim 13, wherein the transmitter is in electrical communication with a mobile application.

15. The fishing net hoop device of claim 13, wherein the mobile application is comprised of a tracking function.

16. The fishing net hoop device of claim 13, wherein the mobile application is comprised of a map function.

17. The fishing net hoop device of claim 13, wherein the mobile application is comprised of a depth function.

18. The fishing net hoop device of claim 4, wherein the tracking device is powered by a battery.

19. A method of using a fishing net hoop device, the method comprising the steps of:
placing a hoop of a fishing net hoop device within a net;
attaching a net of a fishing net hoop device to the hoop via a fastener;
throwing the fishing net hoop device into a body of water; and
determining a position of a fishing net hoop device.

20. The method of claim 19, wherein the position of the fishing net hoop device is determined by a mobile application.
